(19) United States
(12) Patent Application Publication
(10) Pub. No.: US 2009/0046922 A1
(43) Pub. Date: Feb. 19, 2009

(54) Surface Inspecting Apparatus

(76) Inventor: Toru Yoshikawa, Kanagawa-ken (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 11/988,119

(22) PCT Filed: Jun. 29, 2006
(86) PCT No.: PCT/JP2006/313011

§ 371 Date: Dec. 31, 2007

(30) Foreign Application Priority Data
Jul. 4, 2005 (JP) 2005-194531

(51) Int. Cl. G06K 9/00

(52) U.S. Cl. 382/149

(57) ABSTRACT

A wafer to be inspected W is placed on an XY stage 1, and is positioned so that the location to be inspected is under an objective lens 2, after which an inspection image (RBG signals) is captured by a camera 3. Then, the incorporated reference image and inspection image are converted to hue by a computer 4. The two images that have been converted to hue are then compared, and defects are detected on the basis of this result. In this case, there is a table of combinations of RGB values with a high probability that pseudo-defects will occur in defect detection, and any pixels in the reference image having RGB values present in this table are not considered defects even if a defect is detected.

### TECHNICAL FIELD

The present invention relates to a surface inspection apparatus that can be used favorably in the surface inspection of semiconductor wafers, liquid crystal glass substrates, and the like.

### BACKGROUND ART

Conventionally, in the inspection of semiconductor wafers and liquid crystal substrates, the surface of an object of inspection is irradiated with illuminating light, the image intensity of an image of this object of inspection thus obtained is measured, any change in this image intensity is detected, and defects are detected on the basis of this result.

### DISCLOSURE OF THE INVENTION

### Problems to be Solved by the Invention

However, in cases where there is a defect which is such that the optical intensity is the same but the color is different, the defect will be visible to the human eye, but difficult to detect with an inspection apparatus. One conceivable method to deal with this is to capture an image of a normal object (reference image) and an image of the object to be inspected (inspection image), convert the resulting R, G, and B values into H (hue), S (saturation), and V (value) information, then compare the hue H or saturation S, or both, and detect defects on the basis of this result (for example, see Japanese Laid-Open Patent Application 2000-162150). In this case, the imaging must be performed under the same conditions both during capture of the reference image and during capture of the inspection image, but capturing both images under exactly the same conditions is difficult due to error in adjusting the quantity of light, error in the exposure time of the camera, quantization error of the camera, and so on. As a result, even though the state of the subject has not changed, the above-mentioned errors can sometimes change the hue or saturation, resulting in a pseudo-defect.

The present invention was devised in light of such circumstances, and it is an object of the present invention to provide a surface inspection apparatus capable of inspection that is free of pseudo-defects.

### Means for Solving the Problems

The first means used to solve the problems described above is a surface inspection apparatus comprising: means for imaging a normal sample that serves as a reference, converting a reference image incorporated as RGB signals into HSV signals, imaging an inspection sample, and converting an inspection image incorporated as RGB signals into HSV signals; a table for storing combinations of RGB values with a high probability that pseudo-defects will occur in defect detection; and defect detection means for eliminating from the reference image any pixels having RGB values present in this table, comparing the two images that have been converted to hue H, and detecting defects on the basis of this result.

The second means used to solve the problems described above is the first means, comprising table production means for determining whether or not the difference between the hue value of RGB reference data and the hue value of data obtained by multiplying the reference data by a specific error amount exceeds a threshold, and storing in the table a combination of RGB for reference data when the threshold is exceeded.

The third means used to solve the problems described above is the first means, comprising table production means for determining whether or not the difference between the hue value of RGB reference data and the hue value of data obtained by multiplying the reference data by a specific error amount exceeds a threshold, converting the RGB of reference data when the threshold is exceeded into HSV, and storing in the table a combination of saturation S and value V.

The fourth means used to solve the problems described above is the second or third means, wherein the specific error amount corresponds to quantization error or adjustment error of the imaging means for imaging the sample.

The fifth means used to solve the problems described above is a surface inspection apparatus comprising: means for imaging a normal sample that serves as a reference, converting a reference image incorporated as RGB signals into HSV signals, imaging an inspection sample, and converting an inspection image incorporated as RGB signals into HSV signals; a table for storing combinations of RGB values with a high probability that pseudo-defects will occur in defect detection; and defect detection means for eliminating from the reference image any pixels having RGB values present in this table, comparing the two images that have been converted to saturation S, and detecting defects on the basis of this result.

The sixth means used to solve the problems described above is the fifth means, comprising table production means for determining whether or not the difference between the saturation value of RGB reference data and the saturation value of data obtained by multiplying the reference data by a specific error amount exceeds a threshold, and storing in the table a combination of RGB for reference data when the threshold is exceeded.

The seventh means used to solve the problems described above is the fifth means, comprising table production means for determining whether or not the difference between the saturation value of RGB reference data and the saturation value of data obtained by multiplying the reference data by a specific error amount exceeds a threshold, converting the RGB of reference data when the threshold is exceeded into HSV, and storing in the table a combination of saturation S and value V.

The eighth means used to solve the problems described above is the sixth or seventh means, wherein the specific error amount corresponds to quantization error or adjustment error of the imaging means for imaging the sample.

### EFFECT OF THE INVENTION

The present invention makes it possible to provide a surface inspection apparatus capable of inspection that is free of pseudo-defects.

### BRIEF DESCRIPTION OF THE DRAWINGS

FIG. 1 is a concept diagram of a surface inspection apparatus.

FIG. 2 is a flowchart of defect inspection processing performed by a surface inspection apparatus.

FIG. 3 is a flowchart of table production processing or the like for eliminating pseudo-defects with a surface inspection apparatus.

FIG. 4 is a diagram in which the region where pseudo-defects are likely to occur is plotted with saturation and value as the axes, in an apparatus for detecting surface defects on the basis of a difference in hue between a reference image and an inspection image.

FIG. 5 is a diagram in which the region where pseudo-defects are likely to occur is plotted with saturation and value as the axes, in an apparatus for detecting surface defects on the basis of a difference in saturation between a reference image and an inspection image.

### BEST MODE FOR CARRYING OUT THE INVENTION

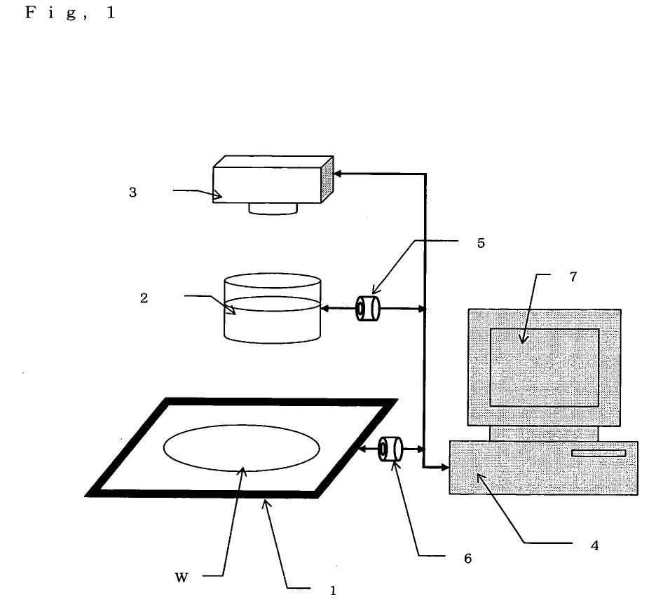

A working configuration of the present invention will be described below with reference to FIGS. 1 through 5.

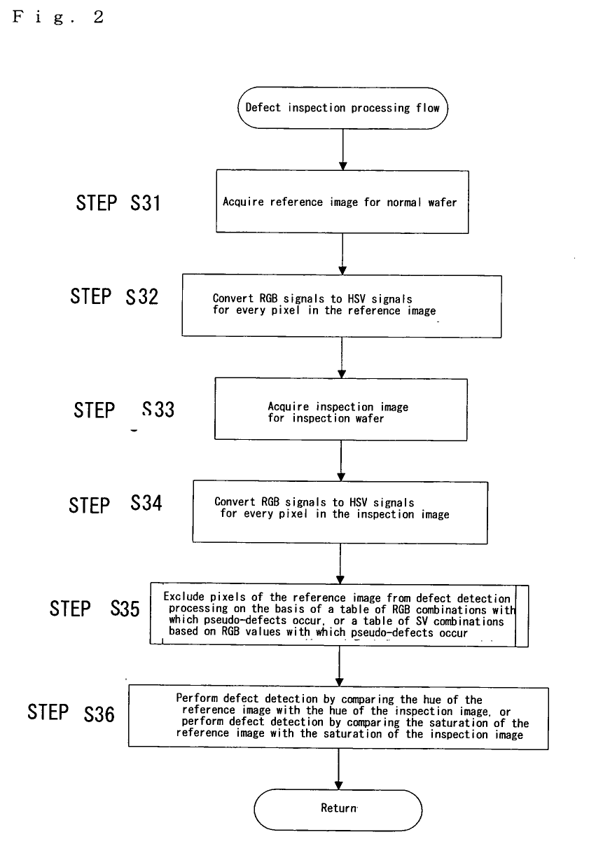

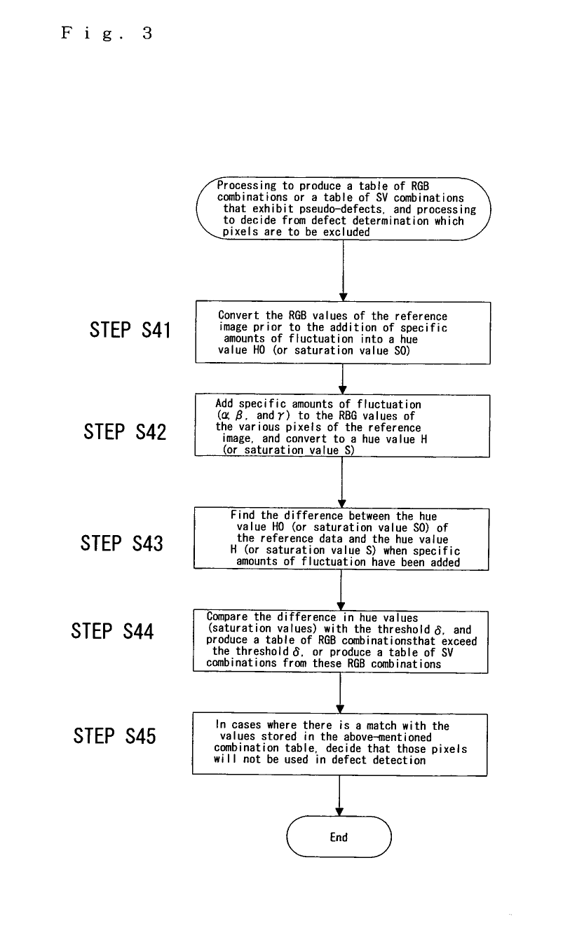

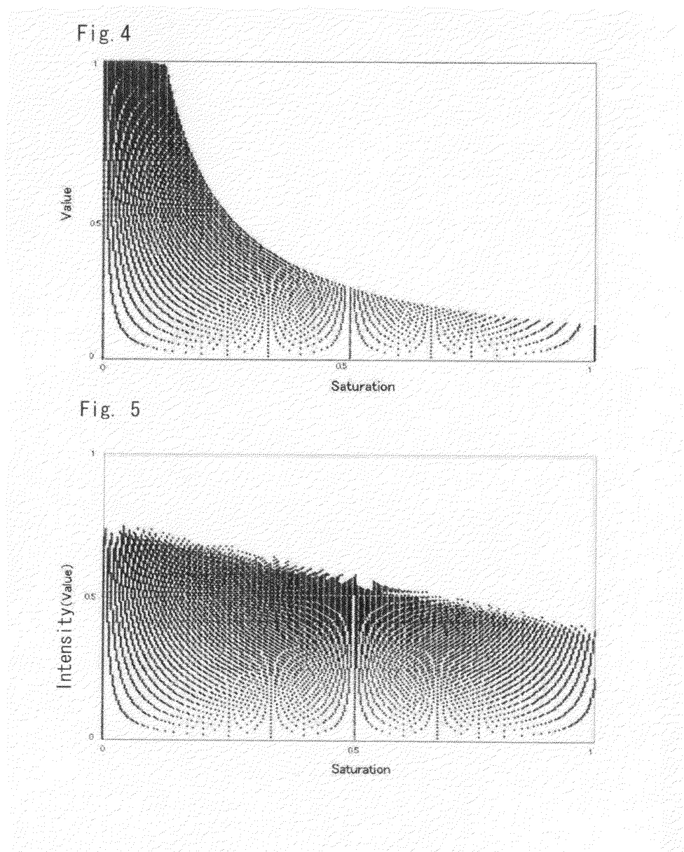

FIG. 1 shows a concept diagram of a surface inspection apparatus. FIG. 2 is a flowchart of defect inspection processing performed by a surface inspection apparatus. FIG. 3 is a flowchart of table production processing or the like for eliminating pseudo-defects with a surface inspection apparatus. FIGS. 4 and 5 are diagrams with plots of the coordinates of the color space where pseudo-defects occur.

In concrete terms, the processing involved in defect inspection by a computer 4 will be described with reference to FIGS. 1 and 2.

First, a normal wafer W is placed on an XY stage 1, and is positioned so that the location to be inspected is under an objective lens 2, after which a reference image is captured by a two-dimensional CCD camera 3 (step S31). Then, the computer 4 converts the RBG signals for each pixel into hue H, saturation S, and value V (step S32). The objective lens 2 is driven in the direction of the Z axis by a driver 5 according to commands from the computer 4, and focus is adjusted. Furthermore, the XY stage 1 is adjusted in the X and Y directions by a driver 6 according to commands from the computer 4.

At the time of inspection, a non-inspection wafer W is placed on the XY stage 1, and is positioned so that the location to be inspected is under the objective lens 2, after which an inspection image is captured by the camera 3 (step S33). Then, the computer 4 converts the RBG signals for each pixel into hue H, saturation S, and value V (step S34).

Although detail of this will be described later, the computer 4 eliminates pixels of the reference image from defect processing on the basis of a table of RGB combinations in which pseudo-defects occur, after which the hue of the reference image is compared to the hue of the inspection image, and defects are detected from the difference between the hues. Similarly, the computer 4 eliminates pixels of the reference image from defect processing on the basis of a table of SV combinations in which pseudo-defects occur, after which the saturation of the reference image is compared to the saturation of the inspection image, and defects are detected from the difference between the saturations (steps S35 and S36). As a result, the defective sites are displayed on a monitor 7 of the computer 4.

The formulas for converting from an RGB space to an HSV space are known, and are as follows. In these formulas, the red R, green G, and blue B of the RGB space are expressed by real number values of 0 to 1. Furthermore, the hue H of the HSV space is the hue angle expressed by a real number value from 0 to 360°, while the saturation S and value V are expressed by real number values of 0 to 1.

Specifically, if we let “max” be the largest of the R, B, and G values, and “min” be the smallest, then we obtain the following:

V=max (1)

S=(max−min)/max (2)

(Here, when max=0, S=0.)

H=60×{(G−B)/(max−min)}(when R=max)

H=60×{2+(B−R)/(max−min)}(when G=max)

H=60×{4+(R−G)/(max−min)}(when B=max) (3)

(Here, when H<0, 360 is added to H. Or, when S=0, H=0.)

Changes in hue and saturation can be detected in this way. However, as was described above, errors can occur in the image that is output from the camera due to error in adjusting the quantity of light, fluctuation in the exposure time, quantization error of the CCD camera 3 used to capture the inspection image, and so on. As a result, even though the state of the subject has not changed, there are cases in which the hue and saturation will change and produce pseudo-defects due to output error in the camera 3. The reason for this is as follows: namely, in cases where an image of an RGB space is converted into an image of an HSV space, there are RGB combinations in which a small change in RGB becomes a large change in hue and saturation.

In this working configuration, such RGB combinations with which tiny changes in RGB result in large changes in hue and saturation are produced in the form of a table, and pseudo-defects are eliminated by excluding from inspection any data for pixels of a reference image having these combinations during inspection.

An example of a method for producing such a table will be described below with reference to FIG. 3.

Even in cases where there are no defects, the amounts of fluctuation in RGB values generated by error in adjusting the quantity of light, fluctuation in the exposure time, quantization error of the CCD camera 3 used to capture the inspection image, and so on are designated as ±α, ±β, and ±γ, respectively. Furthermore, we will let δ be the threshold for concluding that there is a defect if the hue difference exceeds this value in hue inspection.

We will let R, G, and B be data serving as a reference (the data used as the RGB values on the reference image side), and let H₀ be the result of calculating the corresponding hue using Formulas (1) and (3) given above.

Next, the hue is similarly calculated for a case in which α, β, and γ errors occur in the reference data (RGB) (step S42), and the difference from the hue value H₀ of the reference data is calculated (step S43). Specifically:

We let D1 be the difference between the hue value H₀ of the reference data and the hue value of (R−α, G−β, B−γ).
We let D2 be the difference between the hue value H₀ of the reference data and the hue value of (R−α, G−β, B).
We let D3 be the difference between the hue value H₀ of the reference data and the hue value of (R−α, G−β, B+γ).
We let D4 be the difference between the hue value H₀ of the reference data and the hue value of (R−α, G, B−γ).
We let D5 be the difference between the hue value H₀ of the reference data and the hue value of (R−α, G, B).
We let D6 be the difference between the hue value H₀ of the reference data and the hue value of (R−α, G, B+γ).
We let D7 be the difference between the hue value H₀ of the reference data and the hue value of (R−α, G+β, B−γ).
We let D8 be the difference between the hue value H₀ of the reference data and the hue value of (R−α, G+β, B).
We let D9 be the difference between the hue value H₀ of the reference data and the hue value of (R−α, G+β, B+γ).
We let D10 be the difference between the hue value H₀ of the reference data and the hue value of (R, G−β, B−γ).
We let D11 be the difference between the hue value H₀ of the reference data and the hue value of (R, G−β, B).
We let D12 be the difference between the hue value H₀ of the reference data and the hue value of (R, G−β, B+γ).
We let D13 be the difference between the hue value H₀ of the reference data and the hue value of (R, G, B−γ).
We let D14 be the difference between the hue value H₀ of the reference data and the hue value of (R, G, B+γ).
We let D15 be the difference between the hue value H₀ of the reference data and the hue value of (R, G+β, B−γ).
We let D16 be the difference between the hue value H₀ of the reference data and the hue value of (R, G+β, B).
We let D17 be the difference between the hue value H₀ of the reference data and the hue value of (R, G+β, B+γ).
We let D18 be the difference between the hue value H₀ of the reference data and the hue value of (R+α, G−β, B−γ).
We let D19 be the difference between the hue value H₀ of the reference data and the hue value of (R+α, G−β, B).
We let D20 be the difference between the hue value H₀ of the reference data and the hue value of (R+α, G−β, B+γ).
We let D21 be the difference between the hue value H₀ of the reference data and the hue value of (R+α, G, B−γ).
We let D22 be the difference between the hue value H₀ of the reference data and the hue value of (R+α, G, B).
We let D23 be the difference between the hue value H₀ of the reference data and the hue value of (R+α, G, B+γ).
We let D24 be the difference between the hue value H₀ of the reference data and the hue value of (R+α, G+β, B−γ).
We let D25 be the difference between the hue value H₀ of the reference data and the hue value of (R+α, G+β, B).
We let D26 be the difference between the hue value H₀ of the reference data and the hue value of (R+α, G+β, B+γ).

Then, in cases where any of the absolute values of the differences D1 through D14 in the hue value exceeds the threshold δ, at which it is determined that there are defects in hue inspection, the reference data (RGB) thereof is assumed to be a combination with which pseudo-defects are likely to occur. This calculation is performed for all combinations of R=0 to 1, G=0 to 1, and B=0 to 1, and RGB combinations with which pseudo-defects are likely to occur are extracted. Then, any of the pixels of the reference image having these RGB values are not used for defect detection. To this end, a table of these RGB combinations is produced, and in cases where the RGB values of the pixels of the reference image match values stored in this table, those pixels are not used for defect detection (steps S44 and S45).

Alternatively, combinations of saturation S and value V are found from these RGB combinations, and a table of the combinations of saturation S and value V is produced. In cases where a combination of saturation S and value V when the reference image has been converted into an HSV space matches a combination stored in this table, those pixels are not used for defect detection (steps S44 and S45).

In the above description, a method was described for producing ahead of time a table for eliminating pseudo-defects. However, if calculation speed poses no problem, then calculation may be performed during defect detection without having a table, and it may be determined whether or not each pixel of the reference image is to be subjected to pseudo-defect elimination.

Moreover, pseudo-defects can be eliminated more accurately by having a plurality of tables according to the thresholds δ of defect detection, and using the table that fits the threshold δ of defect detection, or by performing calculation according to the threshold δ of defect detection during defect detection.

FIG. 4 is a graph of the calculation results when α=β=γ=3/255 and δ=8/255, for 16,777,216 combinations of R=I/255 (I=0 to 255), G=J/255 (J=0 to 255), and B=K/255 (K=0 to 255), plotted with the hue S on the horizontal axis and the value V on the vertical axis. The plotted region is a region excluded from defect determination as having a high probability that pseudo-defects will occur.

It can be seen from FIG. 4 that pseudo-defects can occur when the saturation S is low and when the value V is low. The explanations for this are that when the saturation S is low, the red R, green G, and blue B values are closer together, appearing rather white, so that if any of these changes, the hue H changes greatly, and that when the value V is low, the red R, green G, and blue B values are all small, so that if any of these changes, the hue H changes greatly.

Next, a method for producing the table used to eliminate pseudo-defects for saturation S will be described. Furthermore, the above-mentioned processing flow shown in FIG. 3 can be used.

In the following description, α, β, and γ are used in the same meanings as in the description of the method for producing the table for eliminating pseudo-defects for hue H. Of course, this does not mean that the values of these are the same as those in the case of the method for producing the table for eliminating pseudo-defects for hue H. Moreover, we will let ε be the threshold at which it is determined that there is a defect when the saturation difference exceeds this value in saturation inspection.

We will let R, G, and B be data serving as a reference (the data used as the RGB values on the reference image side), and let S₀ be the result of calculating the corresponding saturation using Formulas (1) and (2) given above.

Next, the saturation is similarly calculated for a case in which α, β, and γ errors occur in the reference data (RGB), and the difference from the saturation value S₀ of the reference data is calculated. Specifically:

We let D1 be the difference between the saturation value S₀ of the reference data and the saturation value of (R−α, G−β, B−γ).
We let D2 be the difference between the saturation value S₀ of the reference data and the saturation value of (R−α, G−β, B).
We let D3 be the difference between the saturation value S₀ of the reference data and the saturation value of (R−α, G−β, B+γ).
We let D4 be the difference between the saturation value S₀ of the reference data and the saturation value of (R−α, G, B−γ).
We let D5 be the difference between the saturation value S₀ of the reference data and the saturation value of (R−α, G, B).
We let D6 be the difference between the saturation value S₀ of the reference data and the saturation value of (R−α, G, B+γ).
We let D7 be the difference between the saturation value S₀ of the reference data and the saturation value of (R−α, G+β, B−γ).
We let D8 be the difference between the saturation value S₀ of the reference data and the saturation value of (R−α, G+β, B).
We let D9 be the difference between the saturation value S₀ of the reference data and the saturation value of (R−α, G+β, B+γ).
We let D10 be the difference between the saturation value S₀ of the reference data and the saturation value of (R, G−β, B−γ).
We let D11 be the difference between the saturation value S₀ of the reference data and the saturation value of (R, G−β, B).
We let D12 be the difference between the saturation value S₀ of the reference data and the saturation value of (R, G−β, B+γ).
We let D13 be the difference between the saturation value S₀ of the reference data and the saturation value of (R, G, B−γ).
We let D14 be the difference between the saturation value S₀ of the reference data and the saturation value of (R, G, B+γ).
We let D15 be the difference between the saturation value S₀ of the reference data and the saturation value of (R, G+β, B−γ).
We let D16 be the difference between the saturation value S₀ of the reference data and the saturation value of (R, G+β, B).
We let D17 be the difference between the saturation value S₀ of the reference data and the saturation value of (R, G+β, B+γ).
We let D18 be the difference between the saturation value S₀ of the reference data and the saturation value of (R+α, G−β, B−γ).
We let D19 be the difference between the saturation value S₀ of the reference data and the saturation value of (R+α, G−β, B).
We let D20 be the difference between the saturation value S₀ of the reference data and the saturation value of (R+α, G−β, B).
We let D21 be the difference between the saturation value S₀ of the reference data and the saturation value of (R+α, G, B−γ).
We let D22 be the difference between the saturation value S₀ of the reference data and the saturation value of (R+α, G, B).
We let D23 be the difference between the saturation value S₀ of the reference data and the saturation value of (R+α, G, B+γ).
We let D24 be the difference between the saturation value S₀ of the reference data and the saturation value of (R+α, G+β, B−γ).
We let D25 be the difference between the saturation value S₀ of the reference data and the saturation value of (R+α, G+β, B).
We let D26 be the difference between the saturation value S₀ of the reference data and the saturation value of (R+α, G+β, B+γ).

Then, in cases where any of the absolute values of the differences D1 through D14 in the saturation value exceeds the threshold δ, at which it is determined that there are defects in saturation inspection, the reference data (RGB) thereof is assumed to be a combination with which pseudo-defects are likely to occur. This calculation is performed for all combinations of R=0 to 1, G=0 to 1, and B=0 to 1, and RGB combinations with which pseudo-defects are likely to occur are extracted. Then, any of the pixels of the reference image having these RGB values are not used for defect detection. To this end, a table of these RGB combinations is produced, and in cases where the RGB values of the pixels of the reference image match values stored in this table, those pixels are not used for defect detection.

Alternatively, combinations of saturation S and value V are found from these RGB combinations, and a table of the combinations of saturation S and value V is produced. In cases where a combination of saturation S and value V when the reference image has been converted into an HSV space matches a combination stored in this table, those pixels are not used for defect detection.

FIG. 5 is a graph of the calculation results when α=β=γ=3/255 and δ=8/255, for 16,777,216 combinations of R=I/255 (I=0 to 255), G=J/255 (J=0 to 255), and B=K/255 (K=0 to 255), plotted with the hue S on the horizontal axis and the value (intensity) V on the vertical axis. The plotted region is a region excluded from defect determination as having a high probability that pseudo-defects will occur. It can be seen from FIG. 5 that pseudo-defects can occur when the value V is low.

For the description here, an HSV space was used for a color space expressed by hue, saturation, and value, but inspection and defect elimination can also be performed using another color space, such as an HSI space. In the case of an HSI space, however, the values that can be assumed by the intensity I (corresponds to the value V with an HSV space) differ with the value of the hue H, so that the table becomes more difficult to manage.

1. A surface inspection apparatus, comprising:
means for imaging a normal sample that serves as a reference, converting a reference image incorporated as RGB signals into HSV signals, imaging an inspection sample, and converting an inspection image incorporated as RGB signals into HSV signals;
a table for storing combinations of RGB values with a high probability that pseudo-defects will occur in defect detection; and
defect detection means for eliminating from the reference image any pixels having RGB values present in this table, comparing the two images that have been converted to hue H, and detecting defects on the basis of this result.

2. The surface inspection apparatus according to claim 1, comprising table production means for determining whether or not the difference between the hue value of RGB reference data and the hue value of data obtained by multiplying the reference data by a specific error amount exceeds a threshold, and storing in the table a combination of RGB for reference data when the threshold is exceeded.

3. The surface inspection apparatus according to claim 1, comprising table production means for determining whether or not the difference between the hue value of RGB reference data and the hue value of data obtained by multiplying the reference data by a specific error amount exceeds a threshold, converting the RGB of reference data when the threshold is exceeded into HSV, and storing in the table a combination of saturation S and value V.

4. The surface inspection apparatus according to claim 2, wherein the specific error amount corresponds to quantization error or adjustment error of the imaging means for imaging the sample.

5. The surface inspection apparatus according to claim 3, wherein the specific error amount corresponds to quantization error or adjustment error of the imaging means for imaging the sample.

6. A surface inspection apparatus comprising:
means for imaging a normal sample that serves as a reference, converting a reference image incorporated as RGB signals into HSV signals, imaging an inspection sample, and converting an inspection image incorporated as RGB signals into HSV signals;
a table for storing combinations of RGB values with a high probability that pseudo-defects will occur in defect detection; and
defect detection means for eliminating from the reference image any pixels having RGB values present in this table, comparing the two images that have been converted to saturation S, and detecting defects on the basis of this result.

7. The surface inspection apparatus according to claim 6, comprising table production means for determining whether or not the difference between the saturation value of RGB reference data and the saturation value of data obtained by multiplying the reference data by a specific error amount exceeds a threshold, and storing in the table a combination of RGB for reference data when the threshold is exceeded.

8. The surface inspection apparatus according to claim 6, comprising table production means for determining whether or not the difference between the saturation value of RGB reference data and the saturation value of data obtained by multiplying the reference data by a specific error amount exceeds a threshold, converting the RGB of reference data when the threshold is exceeded into HSV, and storing in the table a combination of saturation S and value V.

9. The surface inspection apparatus according to claim 7, wherein the specific error amount corresponds to quantization error or adjustment error of the imaging means for imaging the sample.

10. The surface inspection apparatus according to claim 8, wherein the specific error amount corresponds to quantization error or adjustment error of the imaging means for imaging the sample.
